(19) United States
(12) Patent Application Publication
(10) Pub. No.: US 2010/0007647 A1
(43) Pub. Date: Jan. 14, 2010

(54) ELECTRO-OPTICAL DEVICE AND ELECTRONIC APPARATUS

(75) Inventor: Takehiko KUBOTA, Suwa-shi (JP)

Correspondence Address: OLIFF & BERRIDGE, PLC, P.O. BOX 320850, ALEXANDRIA, VA, 22320-4850, US

(73) Assignee: Seiko Epson Corporation, Tokyo (JP)

(21) Appl. No.: 12/474,863

(22) Filed: May 29, 2009

(30) Foreign Application Priority Data
Jul. 9, 2008 (JP) 2008-178721

(51) Int. Cl. G06F 3/038

(52) U.S. Cl. 345/212; 345/205

(57) ABSTRACT

An electro-optical device includes a plurality of pixel circuits, each of which is disposed at a position corresponding to each intersection position between a plurality of scanning lines and signal lines; a power feeding line which supplies a predetermined potential to the plurality of pixel circuits; and an initialization line which supplies an initialization potential to the plurality of pixel circuits, wherein each of the plurality of pixel circuits includes an electro-optical element, a storage capacitor, an initializer and a driving transistor.

### BACKGROUND

1. Technical Field

The present invention relates to a structure for driving an electro-optical element.

2. Related Art

In the past, an electro-optical device using an electro-optical element such as an organic EL (Electroluminescence) element has been proposed. For example, a pixel circuit disclosed in JP-A-2006-30635 includes a storage capacitor which holds a voltage in accordance with an externally set gray scale, a driving transistor which generates a driving current in accordance with the voltage of the storage capacitor, and an electro-optical element which has a gray scale in accordance with a current amount of the driving current. The voltage across opposite ends of the storage capacitor is initialized by electrically connecting an initialization line to an electrode, where an initialization potential is supplied to the initialization line.

However, in the technology disclosed in JP-A-2006-30635, a variation in a potential of the initialization line may occur due to a current flowing through the initialization line during the initialization (the electric discharge of the storage capacitor). When the voltage of the storage capacitor is different for each pixel circuit due to a variation in a potential of the initialization line after the initialization is carried out, an image quality deteriorates due to a blur or a variation (flicker) of a gray scale.

### SUMMARY

An advantage of some aspects of the invention is that it provides an electro-optical device capable of suppressing a variation in a potential of an initialization line used to initialize a voltage of a storage capacitor of a pixel circuit.

According to an aspect of the invention, there is provided an electro-optical device including: a plurality of pixel circuits, each of which is disposed at a position corresponding to each intersection position between a plurality of scanning lines and signal lines; a power feeding line which supplies a predetermined potential to the plurality of pixel circuits; and an initialization line which supplies an initialization potential to the plurality of pixel circuits, wherein each of the plurality of pixel circuits includes: an electro-optical element which has a gray scale in accordance with a current amount of a driving current supplied from the power feeding line; a storage capacitor (for example, storage capacitors C0 to C2 shown in FIG. 2 or a storage capacitor C2 shown in FIG. 11) of which a voltage across opposite ends is set in accordance with a potential of the signal line; an initializer (for example, transistors TR1 to TR3 shown in FIG. 2 or a transistor TR4 shown in FIG. 11) which initializes the voltage across opposite ends of the storage capacitor by electrically connecting the initialization line to the storage capacitor; and a driving transistor which controls the current amount of the driving current in accordance with the voltage of the storage capacitor, and wherein the initialization line includes a portion which is disposed in each pixel circuit so as to overlap with the power feeding line with an insulating layer interposed therebetween. With such a configuration, since the capacitor is formed at the portion where the initialization line and the power feeding line overlap with each other with the insulating layer interposed therebetween, it is possible to suppress a variation in a potential of the initialization line (or a variation in a potential of the power feeding line).

The initialization line may include a first portion (for example, a portion 62A shown in FIG. 7 or a portion 64B shown in FIG. 13) which is disposed in each pixel circuit so as to overlap with the power feeding line and a second portion (for example, a portion 62B shown in FIG. 7 or a portion 64C shown in FIG. 13) which is disposed in each pixel circuit and is formed on the opposite side of the first portion with the power feeding line interposed therebetween so as to be electrically connected to the first portion. With such a configuration, since there are provided a portion (for example, a capacitor CP1 shown in FIG. 8 or 14) where the first portion overlaps with the power feeding line and a portion (for example, a capacitor CP2 shown in FIG. 8 or 14) where the second portion overlaps with the power feeding line, it is possible to effectively suppress a variation in a potential of the initialization line (or a variation in a potential of the power feeding line).

The driving transistor may include a semiconductor layer, a gate electrode which faces the semiconductor layer with a gate insulating layer interposed therebetween, and an interconnection layer which is formed on a surface of an insulating layer covering the gate electrode so as to be electrically connected to the semiconductor layer; the power feeding line may include a portion which is formed of the same layer as that of the gate electrode; the first portion may be formed of the same layer as that of the interconnection layer; and the second portion may be formed of the same layer as that of the semiconductor layer. With such a configuration, since the power feeding line or the initialization line is formed of the same layer as those of the respective parts of the driving transistor, it is possible to simply form the pixel circuit compared with the case where the power feeding line or the initialization line is formed by a process separate from a process of forming the driving transistor. Additionally, in the configuration in which the gate insulating layer is thinner than the insulating layer, it is advantageous in that a sufficient capacitance is ensured for a capacitor (for example, a capacitor CP2 shown in FIG. 8 or 14) formed by the second portion and the power feeding line.

The power feeding line may include a third portion (for example, a portion 53B shown in FIG. 9) which is disposed in each pixel circuit so as to overlap with the initialization line and a fourth portion (for example, a portion 53C shown in FIG. 9) which is disposed in each pixel circuit and is formed on the opposite side of the third portion with the initialization line interposed therebetween so as to be electrically connected to the third portion. With such a configuration, since there are provided a portion (for example, a capacitor CP1 shown in FIG. 10) where the third portion overlaps with the initialization line and a portion (for example, a capacitor CP2 shown in FIG. 10) where the fourth portion overlaps with the initialization line, it is possible to effectively suppress a variation in a potential of the initialization line (or a variation in a potential of the power feeding line).

The driving transistor may include a semiconductor layer, a gate electrode which faces the semiconductor layer with a gate insulating layer interposed therebetween, and an interconnection layer which is formed on a surface of an insulating layer covering the gate electrode so as to be electrically connected to the semiconductor layer; wherein the initialization line may include a portion which is formed of the same layer as that of the gate electrode, the third portion may be formed of the same layer as that of the interconnection layer, and the fourth portion may be formed of the same layer as that of the semiconductor layer. With such a configuration, since the power feeding line or the initialization line is formed of the same layer as those of the respective parts of the driving transistor, it is possible to simply form the pixel circuit compared with the case where the power feeding line or the initialization line is formed by a process separate from a process of forming the driving transistor. Additionally, in the configuration in which the gate insulating layer is thinner than the insulating layer, it is advantageous in that a sufficient capacitance is ensured for a capacitor (for example, a capacitor CP2 shown in FIG. 10) formed by the fourth portion and the initialization line.

In the example in which the power feeding line and the initialization line extend in a direction intersecting each other, one of the power feeding line and the initialization line may include a portion which is disposed in each pixel circuit and branches from an intersection position between the power feeding line and the initialization line so as to overlap with the other of the power feeding line and the initialization line. For example, in the configuration in which the power feeding line extends in a first direction and the initialization line extends in a second direction intersecting the first direction, the power feeding line includes a portion (for example, a branch portion 51 shown in FIG. 4, 7, or 9) which branches in the second direction so as to overlap with the initialization line. With such a configuration, it is possible to sufficiently ensure an area (a capacitor between the power feeding line and the initialization line) where the power feeding line overlaps with the initialization line in the pixel circuit.

In the example in which the power feeding line and the initialization line extend in a direction parallel to each other, one of the power feeding line and the initialization line may include a portion which is disposed in each pixel circuit and branches so as to overlap with the other of the power feeding line and the initialization line. For example, in the configuration in which the power feeding line and the initialization line extend in a first direction, the initialization line includes a portion (for example, a portion 64B shown in FIG. 13) which branches in a second direction intersecting the first direction so as to overlap with the power feeding line. With such a configuration, it is possible to sufficiently ensure an area (a capacitor between the power feeding line and the initialization line) where the power feeding line overlaps with the initialization line in the pixel circuit.

According to another aspect of the invention, there is provided an electronic apparatus including the electro-optical device according to the aspect of the invention. A typical example of the electronic apparatus includes an apparatus which uses an electro-optical device as a display device. As the electronic apparatus according to the invention, a personal computer or a cellular phone is exemplified. Moreover, the application of the electro-optical device according to the invention is not limited to the application of the display of the image. For example, the electro-optical device may be applied to an exposure device (exposure head) used to form a latent image on an image carrier such as a photosensitive drum by means of irradiation of a beam.

### BRIEF DESCRIPTION OF THE DRAWINGS

The invention will be described with reference to the accompanying drawings, wherein like numbers reference like elements.

FIG. 1 is a block diagram showing an electro-optical device according to a first embodiment of the invention.

FIG. 2 is a circuit diagram showing a pixel circuit.

FIG. 3 is a timing chart showing an operation of the electro-optical device.

FIG. 4 is a top view showing a pixel circuit P.

FIG. 5 is a sectional view taken along the line V-V in FIG. 4.

FIG. 6 is a sectional view taken along the line VI-VI in FIG. 4.

FIG. 7 is a top view showing the pixel circuit according to a second embodiment of the invention.

FIG. 8 is a sectional view taken along the line VIII-VIII in FIG. 7.

FIG. 9 is a top view showing the pixel circuit according to a third embodiment of the invention.

FIG. 10 is a sectional view taken along the line X-X in FIG. 9.

FIG. 11 is a circuit diagram showing the pixel circuit according to a fourth embodiment of the invention.

FIG. 12 is a timing chart showing an operation of the electro-optical device.

FIG. 13 is a top view showing the pixel circuit.

FIG. 14 is a sectional view taken along the line XIV-XIV in FIG. 13.

FIG. 15 is a top view showing the pixel circuit according to a modified example.

FIG. 16 is a perspective view showing an electronic apparatus (personal computer).

FIG. 17 is a perspective view showing an electronic apparatus (cellular phone).

FIG. 18 is a perspective view showing an electronic apparatus (portable information terminal).

### DESCRIPTION OF EXEMPLARY EMBODIMENTS

### A: First Embodiment

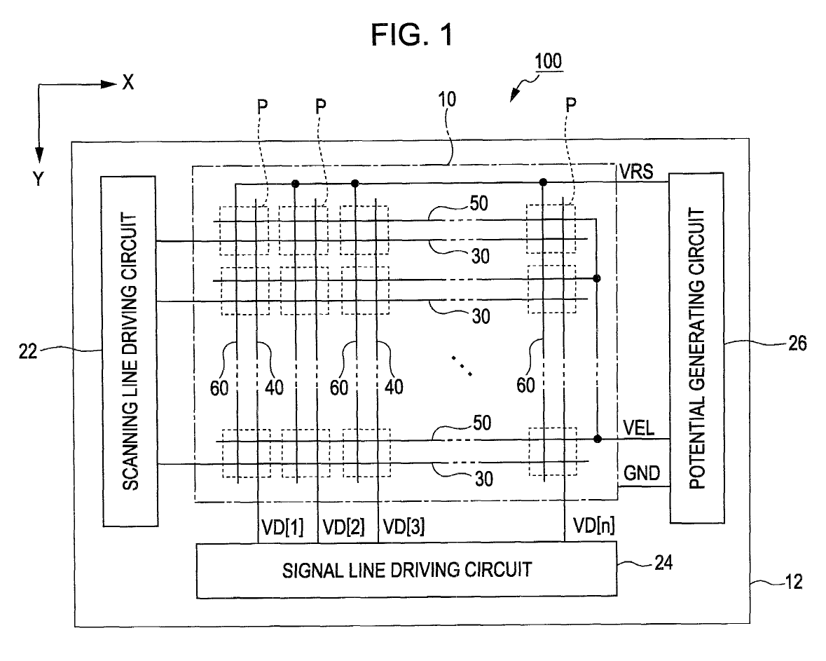

FIG. 1 is a block diagram showing an electro-optical device according to a first embodiment of the invention. An electro-optical device 100 serves as a display device which is mounted to an electronic apparatus so as to display an image thereon. As shown in FIG. 1, the electro-optical device 100 includes an element unit 10 which has a plurality of pixel circuits P arranged in a plane shape; a scanning line driving circuit 22 and a signal line driving circuit 24 which drive each pixel circuit P; and a potential generating circuit 26 which generates a potential used in the electro-optical device 100. In addition, a part or an entire part of the scanning line driving circuit 22, the signal line driving circuit 24, and the potential generating circuit 26 may be provided in a single circuit. Alternatively, the scanning line driving circuit 22 or the signal line driving circuit 24 may be separately mounted to a plurality of integrated circuits.

The element unit 10 shown in FIG. 1 is disposed on a substrate 12. The element unit 10 has m pairs of control line groups 30 which extends in an X direction and n number of signal lines 40 which extend in a Y direction intersecting (perpendicular to) the x direction (where m and n are natural numbers). Each of the plurality of pixel circuits P is disposed at an intersection position of each control line group 30 and each signal line 40 so as to have a matrix shape of “m rows×n columns”. In addition, the element unit 10 has m number of power feeding lines 50 which extend in the X direction together with the control line groups 30 and n number of initialization lines 60 which extend in the Y direction together with the signal lines 40.

The scanning line driving circuit 22 sequentially selects the plurality of pixel circuits P by the unit of row. The signal line driving circuit 24 outputs n channels of gray-scale potentials VDs (VD[1] to VD[n]) in parallel to the signal lines 40 in synchronization with the selection of the scanning line driving circuit 22. The gray-scale potential VD[j] which is output to the signal line 40 at a j-th column (where j=1 to n) upon selecting an i-th row (where i=1 to m) is set to a potential corresponding to a gray-scale value designated by the pixel circuit P at the j-th column included in the i-th row.

The potential generating circuit 26 generates a high level potential VEL, a low level potential GND, and an initialization potential VRS set to a predetermined value. The potential VEL is output to the m number of power feeding lines 50 so as to be commonly supplied to the pixel circuits P. The initialization potential VRS is output to the n number of initialization lines 60 so as to be commonly supplied to the pixel circuits P. In addition, a circuit for generating the potential VEL or the potential GND may be provided separately from a circuit for generating the initialization potential VRS.

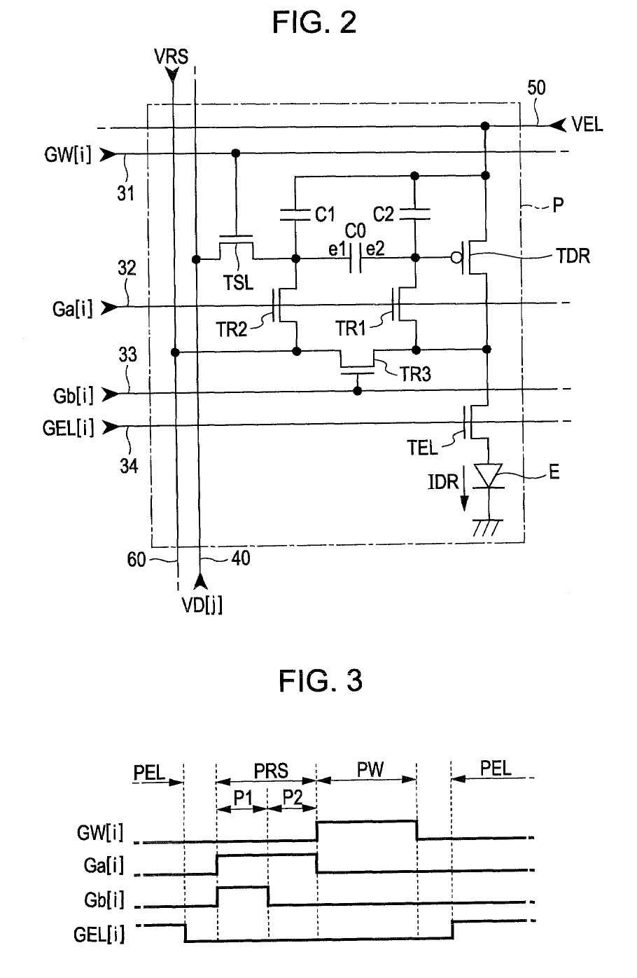

FIG. 2 is a circuit diagram showing the pixel circuit P. In FIG. 2, only one pixel circuit P at the j-th column included in the i-th row is representatively shown. As shown in FIG. 2, the pixel circuit P includes an electro-optical element E which is disposed on a path used to connect the power feeding line 50 for receiving the potential VEL and a ground line for receiving the potential GND to each other. The electro-optical element E is a current-driving-type light emitting element which has a gray scale in accordance with a current amount of a driving current IDR flowing from the power feeding line 50 to the ground line. For example, as the electro-optical element E, an organic EL element having a configuration in which a light emitting layer formed of an organic EL material is interposed between a cathode and an anode facing each other may be desirably used.

As shown in FIG. 2, one pair of the control line groups 30 shown in FIG. 1 is formed by four wiring lines (a scanning line 31, a first control line 32, a second control line 33, and a light emitting control line 34). The scanning line driving circuit 22 supplies a signal to the wiring lines of the control line groups 30. For example, a scanning signal GW[i] for selecting the i-th row is supplied to the scanning line 31. In addition, a first control signal Ga[i] is supplied to the first control line 32, and a second control signal Gb[i] is supplied to the second control line 33. A light emitting control signal GEL[i] is supplied to the light emitting control line 34.

A P-channel-type driving transistor TDR and an N-channel-type light emitting control transistor TEL are disposed on a path of a driving current IDR. In the driving transistor TDR, the drain of the driving transistor TDR is connected to the drain of the light emitting control transistor TEL at the same time when the source of the driving transistor TDR is connected to the power feeding line 50, thereby controlling a current amount of the driving current IDR in accordance with a potential of the gate of the driving transistor TDR. In the light emitting control transistor TEL, the source of the light emitting control transistor TEL is connected to the electro-optical element E (cathode) at the same time when the gate of the light emitting control transistor TEL is connected to the light emitting control line 34, thereby controlling whether the driving current IDR is supplied to the electro-optical element E. In addition, a configuration in which the driving transistor TDR or the light emitting control transistor TEL is disposed between the electro-optical element E and the ground line may be adopted.

A storage capacitor C0 shown in FIG. 2 holds a voltage between electrodes e1 and e2. The electrode e2 is connected to the gate of the driving transistor TDR. An N-channel type selection transistor TSL is interposed between the signal line 40 and the electrode e1 of the storage capacitor C0 so as to control an electric connection (a state where both are electrically connected or not electrically connected to each other) therebetween. The gate of the selection transistor TSL is connected to the scanning line 31. In addition, a storage capacitor C1 is interposed between the electrode e1 and the power feeding line 50 so as to hold a potential of the electrode e1. A storage capacitor C2 is interposed between the electrode e2 and the power feeding line 50 so as to hold a potential of the electrode e2 (the gate of the driving transistor TDR).

An N-channel-type transistor TR1 is interposed between the gate and the drain of the driving transistor TDR. An N-channel-type transistor TR2 is interposed between the initialization line 60 and the electrode e1 of the storage capacitor C0. The gates of the transistors TR1 and TR2 are connected to the first control line 32. In addition, an N-channel-type transistor TR3 is interposed between the transistors TR1 and TR2. The gate of the transistor TR3 is connected to the second control line 33.

FIG. 3 is a timing chart showing an operation of the electro-optical device 100. As shown in FIG. 3, scanning signals GW[1] to GW[m] are sequentially set to a high level (a level meaning the selection of the i-th row) for each writing period (a horizontal scanning period) PW. The first control signal Ga[i] becomes a high level during the initialization period PRS before the start of the writing period PW at which the scanning signal GW[i] becomes a high level. The first control signal Ga[i] is maintained to be a low level during a period except for the initialization period PRS. The initialization period PRS is divided into periods P1 and P2. The period P1 indicates a period at which a voltage across opposite ends of the storage capacitor C0 is initialized to be a predetermined value. The period P2 after the period P1 indicates a period at which a potential of the gate of the driving transistor TDR is set to a potential in accordance with the threshold voltage VTH of the driving transistor TDR.

The second control signal Gb[i] is set to a high level during the period P1, and is set to a low level during a period except for the period P1. The light emitting control signal GEL[i] becomes a high level during a light emitting period PEL before the start of the initialization period PRS at which the first control signal Ga[i] becomes a high level after the writing period PW at which the scanning signal GW[i] becomes a high level. The light emitting control signal GEL[i] is maintained to be a low level during a period except for the light emitting period PEL. Hereinafter, an operation of the pixel circuit P will be described with reference to the initialization period PRS, the writing period PW, and the light emitting period PEL.

Since the first control signal Ga[i] and the second control signal G[i] are set to a high level during the period P1 of the initialization period PRS, the transistors TR1, TR2, and TR3 become an on state. Accordingly, the electrodes e1 and e2 of the storage capacitor C0 are electrically connected to each other, and an initialization potential VRS is supplied from the initialization line 60 to both electrodes e1 and e2. Since the electrodes e1 and e2 are electrically connected to each other, an electric charge accumulated in the storage capacitor C0 is discharged at the time of the start of the initialization period PRS.

Since only the first control signal Ga[i] is set to a high level during the period P2 of the initialization period PRS, the transistors TR1 and TR2 are maintained to be an on state (the transistor TR3 becomes an off state). Accordingly, from the period P1, the initialization potential VRS is continuously supplied from the initialization line 60 to the electrode e1 of the storage capacitor C0 via the transistor TR2. In addition, since the gate and the drain of the driving transistor TDR are diode-connected to each other via the transistor TR1, a potential of the gate (the electrode e2 of the storage capacitor C0) of the driving transistor TDR increases more than the potential VEL of the power feeding line 50 so as to be lower than the threshold voltage VTH. As described above, the voltage across opposite ends of the storage capacitor C0 is initialized to be a predetermined value (|VEL−VTH−VRS|) during the initialization period PRS. In the same manner, the voltages of the storage capacitors C1 and C2 are initialized to be a predetermined value.

Since the selection transistor TSL becomes an on state by setting the scanning signal GW[i] to a high level during the writing period PW, a potential of the electrode e1 of the storage capacitor C0 changes from the initialization potential VRS set during the initialization period PRS to the gray-scale potential VD[j] of the signal line 40. Since the gate of the driving transistor TDR is in an electric floating state due to the transistor TR1 changing to an off state during the writing period PW, a potential of the gate (the electrode e2) of the driving transistor TDR changes from a potential (VEL-VTH) set during the initialization period PRS in accordance with a change amount (VRS->VD[j]) of a potential of the electrode e1. That is, a potential of the gate of the driving transistor TDR is set to a potential in accordance with the gray-scale potential VD[j] and the threshold voltage VTH of the driving transistor TDR.

Since the light emitting control signal GEL[i] becomes a high level during the light emitting period PEL, the light emitting control transistor TEL becomes an on state. Accordingly, the driving current IDR having a current amount in accordance with a potential of the gate of the driving transistor TDR is supplied from the power feeding line 50 to the electro-optical element E via the driving transistor TDR and the light emitting control transistor TEL. The electro-optical element E is controlled by the gray scale (the gray scale in accordance with the gray-scale potential VD[j]) in accordance with the current amount of the driving current IDR. Since the threshold voltage VTH of the driving transistor TDR is reflected in a potential of the gate of the driving transistor TDR during the light emitting period PEL, a blur of the gray scale of the electro-optical element E caused by a difference in the threshold voltages VTH of the driving transistors TDR is compensated.

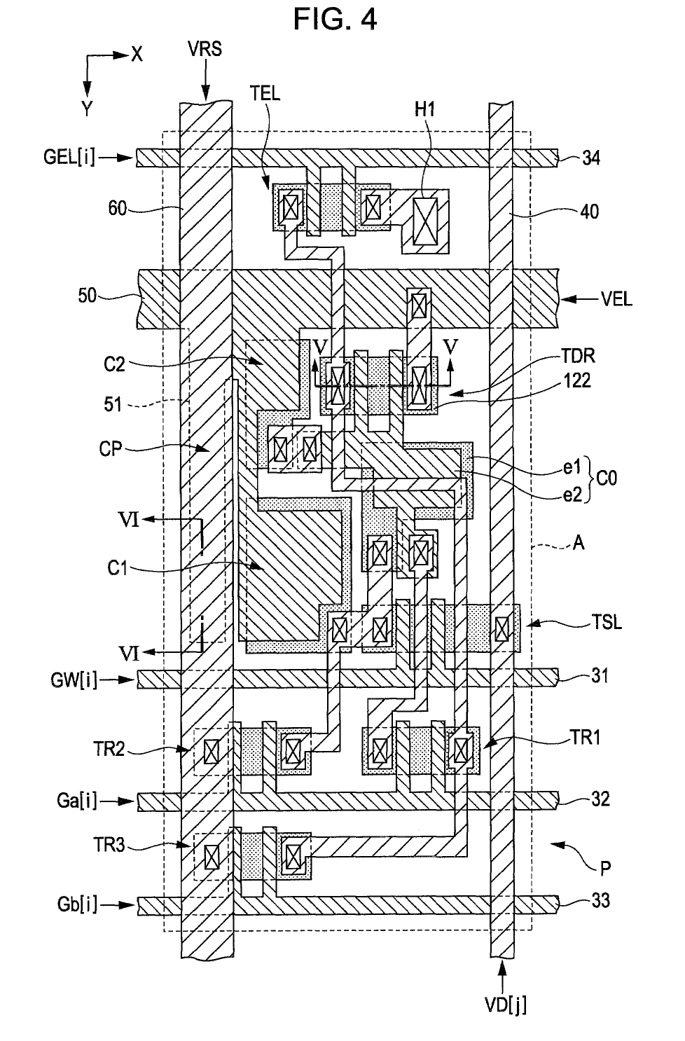

Next, a structure of the pixel circuit P described above will be described. FIG. 4 is a top view showing one pixel circuit P. As shown in FIG. 4, the pixel circuit P is formed in a rectangular unit area A defined on a surface of a substrate 12. In the unit area A, the power feeding line 50 and the scanning line 31 extend in the X direction, and the signal line 40 and the initialization line 60 extend in the Y direction. The driving transistor TDR is disposed in an area surrounded by the power feeding line 50, the scanning line 31, the signal line 40, and the initialization line 60.

The selection transistor TSL is disposed between the driving transistor TDR and the scanning line 31. The light emitting control line 34 extends in the X direction in an area which is located on the opposite side of the driving transistor TDR with the power feeding line 50 interposed therebetween. The light emitting control transistor TEL is disposed between the power feeding line 50 and the light emitting control line 34. In addition, the first control line 32 is formed in an area which is located on the opposite side of the driving transistor TDR with the scanning line 31 interposed therebetween. The second control line 33 is formed in an area which is located on the opposite side of the scanning line 31 with the first control line 32 interposed therebetween. The transistors TR1 and TR2 are disposed between the scanning line 31 and the first control line 32. The transistor TR3 is disposed between the first control line 32 and the second control line 33.

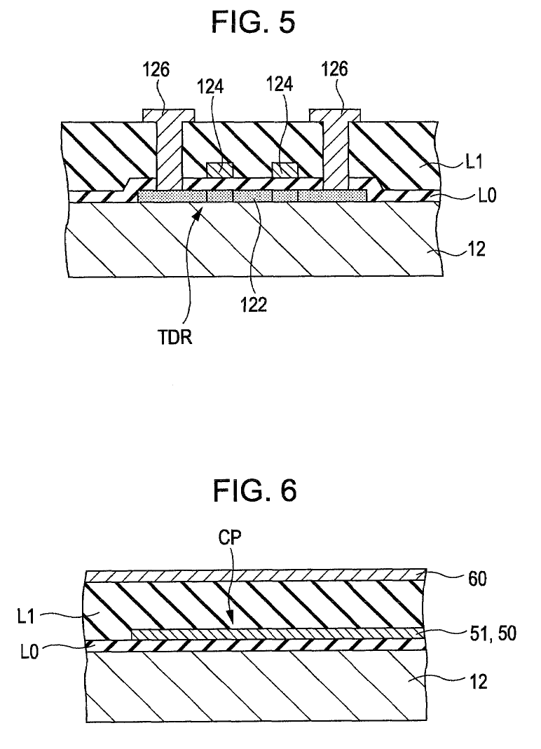

FIG. 5 is a sectional view taken along the line V-V in FIG. 4. The driving transistor TDR includes a semiconductor layer 122 which is formed on the substrate 12 by means of a semiconductor material (for example, polysilicon) and gate electrodes 124 which are opposed to a channel area of the semiconductor layer 122. A gate insulating layer L0 is interposed between the semiconductor layer 122 and the gate electrodes 124 so as to be continuously formed in the entire area of the substrate 12. An insulating layer L1 is disposed on the gate insulating layer L0 provided with the gate electrodes 124 so as to be continuously formed in the entire area of the substrate 12. Interconnection layers 126 (a source electrode and a drain electrode) formed on the insulating layer L1 are electrically connected to the semiconductor layer 122 via a connection hole.

The transistors T (TR1, TR2, TR3, TEL, and TSL) forming the pixel circuit P are formed by a common process of forming the driving transistor TDR. That is, the respective parts of the transistors T and the respective parts of the driving transistor TDR are integrally formed by a common process by selectively removing a single film member (hereinafter, simply described that the respective parts thereof are formed of the same layer). For example, the semiconductor layers of the respective transistors T are formed of the same layer as that of the semiconductor layer 122 of the driving transistor TDR. The gate electrodes of the respective transistors T are formed of the same layer as those of the gate electrodes 124 of the driving transistor TDR. In FIG. 4, the respective conductive members (electrodes or wirings) formed of the same layer are depicted by the common hatching. In addition, the respective transistors forming the pixel circuit P may have a bottom gate structure.

The electrode e1 of the storage capacitor C0 is formed of the same layer as that of the semiconductor layer 122 of the driving transistor TDR, and the electrodes e2 thereof is formed of the same layer as those of the gate electrodes 124 of the driving transistor TDR. In the same manner, each of the storage capacitors C1 and C2 includes the electrode which is formed of the same layer as that of the semiconductor layer 122 and the electrode which is formed of the same layer as those of the gate electrodes 124.

The control line group 30 (the scanning line 31, the first control line 32, the second control line 33, and the light emitting control line 34) and the power feeding line 50 are formed of the same layer as those of the gate electrodes 124 of the driving transistor TDR. In addition, the initialization line 60 and the signal line 40 are formed of the same layer as those of the interconnection layers 126 (the source electrode and the drain electrode) of the driving transistor TDR. The connection relationship between the respective parts of the pixel circuit P has already been described with reference to FIG. 2. The cathode (pixel electrode) of the electro-optical element E is electrically connected to the source electrode of the light emitting control transistor TEL via a connection hole H1 (FIG. 4) of the insulating layer for coating the insulating layer L1.

FIG. 6 is a sectional view taken along the line VI-VI in FIG. 4. As shown in FIGS. 4 and 6, the initialization line 60 overlaps with a branch portion 51 of the power feeding line 50 in a direction perpendicular to the substrate 12. The branch portion 51 is a portion which branches in the Y direction at an intersection position between the initialization line 60 and the power feeding line 50 extending in the x direction and extends in the Y direction at a position right below the initialization line 60. As shown in FIG. 6, the insulating layer L1 is interposed between the power feeding line 50 and the initialization line 60. Accordingly, a capacitor CP is formed by the insulating layer L1 (dielectric substance) between both the power feeding line 50 (the branch portion 51) and the initialization line 60.

Since the capacitor CP is provided in the initialization line 60 as described above, it is possible to suppress a variation in the initialization potential VRS generated when the initialization line 60 is connected to the storage capacitor C0 (a current flows through the initialization line 60) during the initialization period PRS. In the same manner, since the capacitor CP is provided in the power feeding line 50, it is possible to suppress a variation in the potential VEL generated when the driving current IDR flows from the power feeding line 50 to the electro-optical element E. That is, the capacitor CP serves as a capacitor for smoothing a variation in the potentials of the initialization line 60 and the power feeding line 50.

Incidentally, as a configuration for suppressing a variation in a potential of the initialization line 60 or the power feeding line 50, for example, a configuration (hereinafter, referred to as “a comparative example”) in which a capacitor (smoothing capacitor) is disposed in the output terminal of the potential VEL or the initialization potential VRS of the potential generating circuit 26 may be supposed. However, in the comparative example, since the area having the smoothing capacitor is required to be provided between the element unit 10 and the potential generating circuit 26, the configuration having the smoothing capacitor formed on the substrate 12 causes a problem in that a frame area of the substrate 12 (the outside area of the element unit 10) increases. Also, the configuration having the smoothing capacitor formed on the interconnection substrate fixed to the substrate 12 causes a problem in that the interconnection substrate increases in size. Since the capacitor CP according to this embodiment is formed in every pixel circuit P of the element unit 10, it is advantageous in that the frame area or the interconnection substrate does not increase in size.

### B: Second Embodiment

Next, a second embodiment of the invention will be described. In addition, in the respective embodiments described below, the same reference numerals will be given to the same parts as those of the first embodiment, and the detailed description thereof will be appropriately omitted.

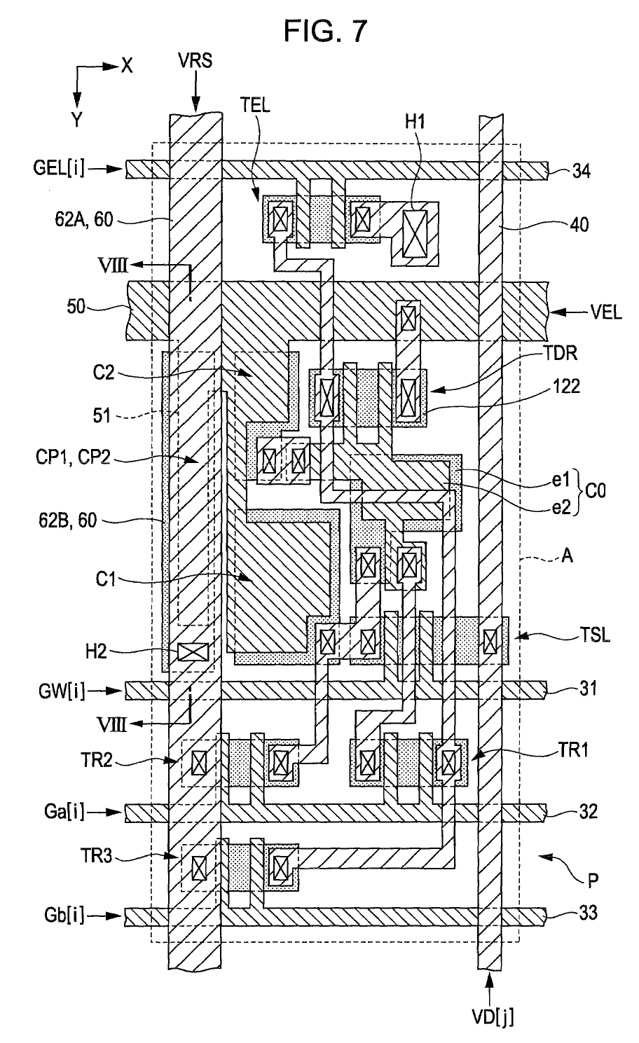

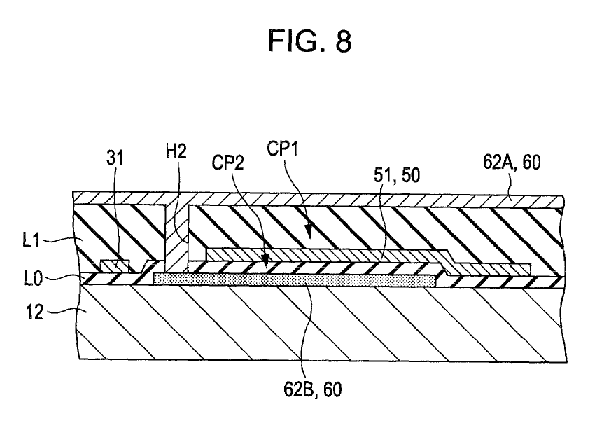

FIG. 7 is a top view showing the pixel circuit P according to this embodiment. FIG. 8 is a sectional view taken along the line VIII-VIII in FIG. 7. As shown in FIG. 7, the initialization line 60 includes a portion 62A and a portion 62B. The portion 62A is a portion which is formed in the same shape as that of the initialization line 60 according to the first embodiment. The portion 62A is formed of the same layer as those of the interconnection layers 126 of the driving transistor TDR so as to extend in the Y direction. The portion 62B is formed of the same layer as that of the semiconductor layer 122 of the driving transistor TDR in each unit area A. As shown in FIGS. 7 and 8, the portion 62B extends in the Y direction so as to overlap with the portion 62A with the power feeding line 50 interposed therebetween. That is, the branch portion 51 of the power feeding line 50 is interposed between the portions 62A and 62B of the initialization line 60. The portion 62A is electrically connected to the portion 62B via a connection hole H2 which penetrates the insulating layer L1 and the gate insulating layer L0.

As shown in FIG. 8, the insulating layer L1 as the dielectric substance is disposed between the power feeding line 50 (the branch portion 51) and the portion 62A of the initialization line 60 so as to form a capacitor CP1. In addition, the gate insulating layer L0 as the dielectric substance is disposed between the power feeding line 50 (the branch portion 51) and the portion 62B of the initialization line 60 so as to form a capacitor CP2. The capacitors CP1 and CP2 are disposed in parallel between the initialization line 60 and the power feeding line 50. Accordingly, compared with the first embodiment in which only the capacitor CP is interposed between the power feeding line 50 and the initialization line 60, it is possible to effectively suppress a variation in the potentials of the initialization line 60 and the power feeding line 50. Particularly, since a film thickness of the gate insulating layer L0 is smaller than that of the insulating layer L1 (a gap between the power feeding line 50 and the portion 62B is small), the capacitor CP2 is capable of easily ensuring a capacitance value sufficient for suppressing a variation in a potential of the initialization line 60 or the power feeding line 50 compared with the capacitor CP1. Accordingly, the advantage of suppressing a variation in the potentials of the initialization line 60 and the power feeding line 50 becomes particularly apparent.

### C: Third Embodiment

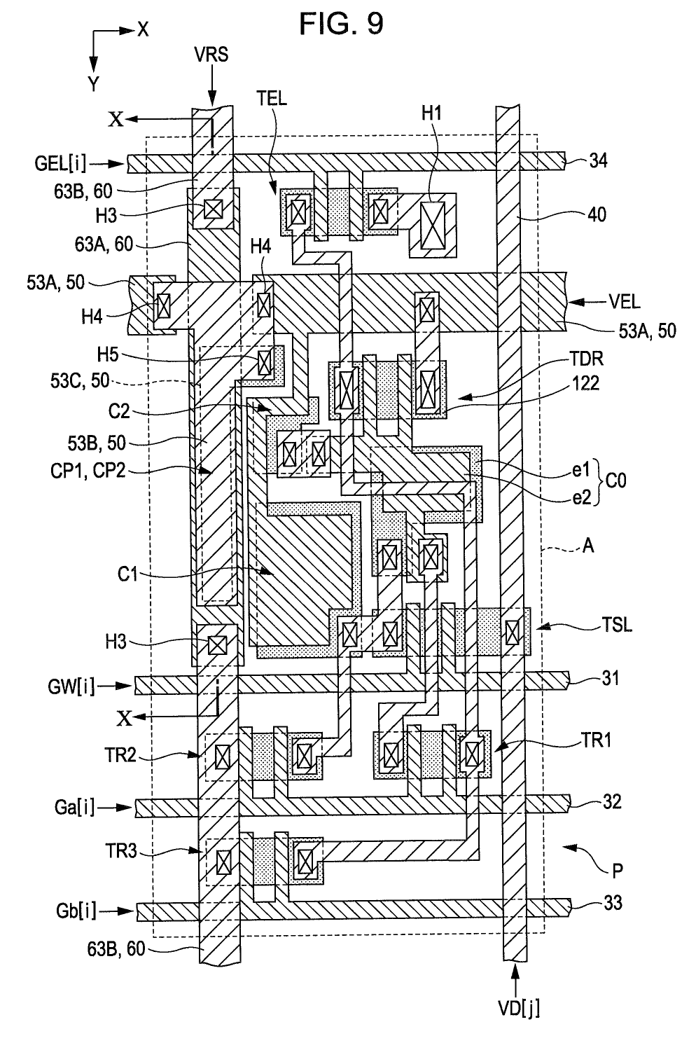

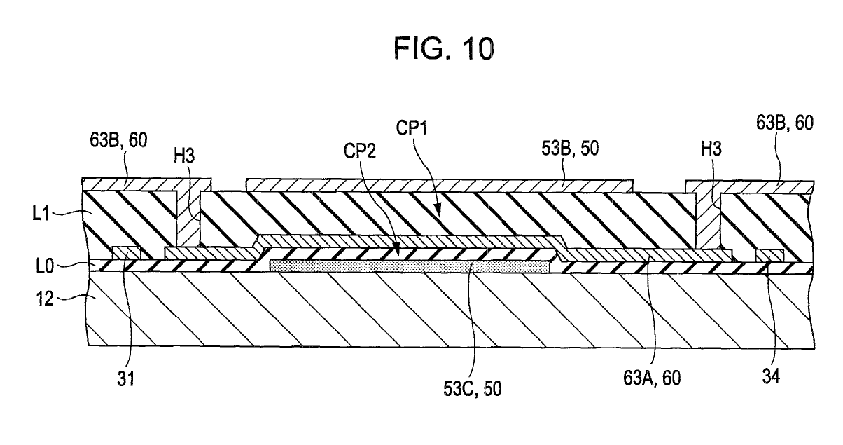

FIG. 9 is a top view showing the pixel circuit P according to a third embodiment of the invention. FIG. 10 is a sectional view taken along the line X-X in FIG. 9. As shown in FIG. 9, the initialization line 60 includes portions 63A and 63B which are alternately arranged in the Y direction. The portion 63A is formed of the same layer as those of the gate electrodes 124 of the driving transistor TDR, and the portion 63B is formed of the same layer as those of the interconnection layers 126 of the driving transistor TDR. The portion 63A is formed in each unit area A so as to extend in the Y direction within a gap between the scanning line 31 and the light emitting control line 34. The portion 63B extends in the Y direction so as to pass over a gap between the portions 63A which are adjacent to each other in the Y direction. As shown in FIGS. 9 and 10, the portion 63B is electrically connected to the portion 63A via a connection hole H3 which penetrates the insulating layer L1.

The power feeding line 50 includes portions 53A, 53B, and 53C. The portion 53A is formed of the same layer as those of the gate electrodes 124 of the driving transistor TDR, the portion 533 is formed of the same layer as those of the interconnection layers 126 of the driving transistor TDR, and the portion 53C is formed of the same layer as that of the semiconductor layer 122 of the driving transistor TDR. The portion 53A extends in the X direction within a gap between the portions 63A of the respective initialization lines 60 which are adjacent to each other in the X direction. The portion 53B is formed in a shape passing over a gap between the portions 53A which are adjacent to each other in the X direction, and is electrically connected to the portions 53A via a connection hole H4 which penetrates the insulating layer L1. As shown in FIG. 9, the portion 53B extends in the Y direction so as to overlap with the portion 63A of the initialization line 60 in a direction perpendicular to the substrate 12.

As shown in FIGS. 9 and 10, the portion 53C extends in the Y direction so as to overlap with the portion 53B with the portion 63A of the initialization line 60 interposed therebetween. That is, the portion 63A of the initialization line 60 is interposed between the portions 53B and 53C of the power feeding line 50. As shown in FIG. 9, the portion 53B is electrically connected to the portion 53C via a connection hole H5 which penetrates the insulating layer L1 and the gate insulating layer L0.

As shown in FIG. 10, the insulating layer L1 as the dielectric substance is disposed between the portion 63A of the initialization line 60 and the portion 53B of the power feeding line 50 so as to form a capacitor CP1. In addition, the gate insulating layer L0 as the dielectric substance is disposed between the portion 63A of the initialization line 60 and the portion 53C of the power feeding line 50 so as to form the capacitor CP2. The capacitors CP1 and CP2 are arranged in parallel between the initialization line 60 and the power feeding line 50. Accordingly, compared with the first embodiment in which only the capacitor CP is interposed between the power feeding line 50 and the initialization line 60, it is possible to effectively suppress a variation in the potentials of the initialization line 60 and the power feeding line 50 in the same manner as the second embodiment. In addition, in the same manner as the second embodiment, it is possible to obtain the advantage of ensuring a capacitance value sufficient for the capacitor CP2 by using the gate insulating layer L0 thinner than the insulating layer L1 as the dielectric substance of the capacitor CP2.

### D: Fourth Embodiment

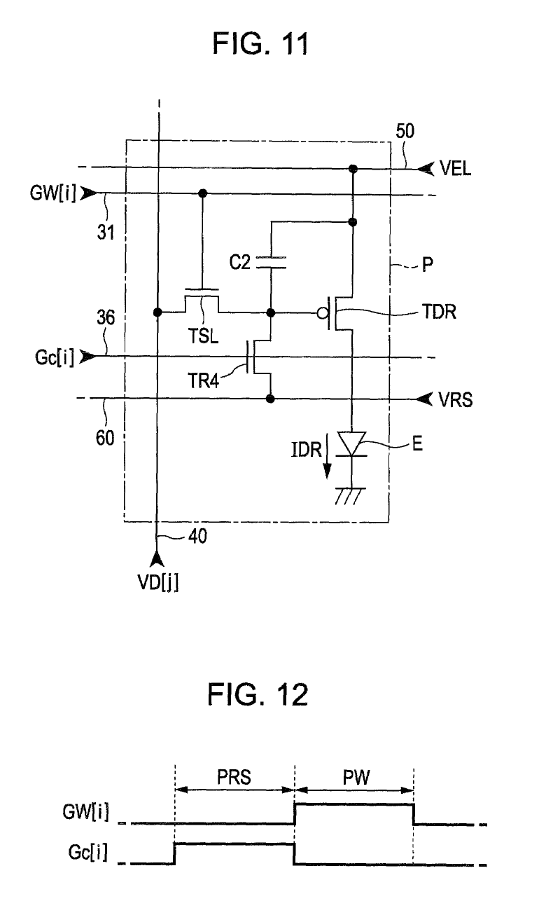

FIG. 11 is a circuit diagram showing the pixel circuit P of the electro-optical device 100 according to a fourth embodiment of the invention. In the same manner as the first embodiment, the driving transistor TDR is disposed on the path of the driving current IDR supplied from the power feeding line 50 to the electro-optical element E. The storage capacitor C2 is interposed between the power feeding line 50 and the gate of the driving transistor TDR.

The selection transistor TSL is interposed between the signal line 40 and the gate of the driving transistor TDR. The transistor TR4 is interposed between the initialization line 60 and the gate of the driving transistor TDR. As shown in FIG. 11, the pair of control line groups 30 according to this embodiment includes the scanning line 31 to which the scanning signal GW[i] is supplied and the control line 36 to which a control signal Gc[i] is supplied. The gate of the selection transistor TSL is connected to the scanning line 31, and the gate of the transistor TR4 is connected to the control line 36.

FIG. 12 is a timing chart showing an operation of the pixel circuit P. As shown in FIG. 12, the control signal Gc[i] supplied to the control line 36 is set to a high level during the initialization period PRS before the start of the writing period PW at which the scanning signal GW[i] of the scanning line 31 becomes a high level. The control signal Gc[i] is maintained to be a low level during a period except for the initialization period PRS.

Since the transistor TR4 becomes an on state by setting the control signal Gc[i] to a high level during the initialization period PRS, the initialization potential VRS is supplied from the initialization line 60 to the gate of the driving transistor TDR via the transistor TR4. Accordingly, a voltage across opposite ends of the storage capacitor C2 is initialized to be a predetermined value (a difference between the potential VEL and the initialization potential VRS) during the initialization period PRS. Meanwhile, since the selection transistor TSL becomes an on state by setting the scanning signal GW[i] to a high level during the writing period PW, the gray-scale potential VD[j] is supplied from the signal line 40 to the gate of the driving transistor TDR. A potential of the gate of the driving transistor TDR is maintained by the storage capacitor C2 even after the writing period PW. Accordingly, the driving current IDR having a current amount in accordance with the gray-scale potential VD[j] is supplied to the electro-optical element E.

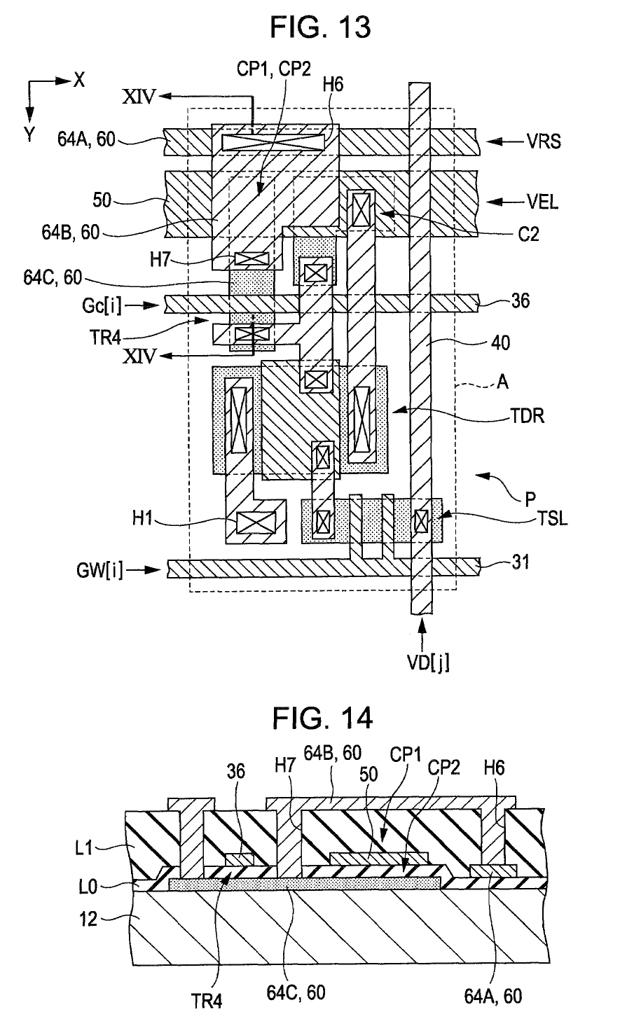

FIG. 13 is a top view showing the pixel circuit P. FIG. 14 is a sectional view taken along the line XIV-XIV in FIG. 13. As shown in FIG. 13, the power feeding line 50 extends in the X direction and the driving transistor TDR is disposed in the unit area A. The power feeding line 50 is formed of the same layer as those of the gate electrodes 124 and the driving transistor TDR. The scanning line 31 is disposed in the area on the opposite side of the power feeding line 50 with the driving transistor TDR interposed therebetween so as to extend in the X direction. The selection transistor TSL is disposed between the driving transistor TDR and the scanning line 31. In addition, the transistor TR4 and the control line 36 are formed between the driving transistor TDR and the power feeding line 50. The storage capacitor C2 is formed by the power feeding line 50 and the electrode formed of the same layer as that of the semiconductor layer 122 of the driving transistor TDR. The connection relationship between the respective parts of the pixel circuit P has already been described with reference to FIG. 11.

The initialization line 60 includes portions 64A, 64B, and 64C. The portion 64A is formed of the same layer as those of the gate electrodes 124 of the driving transistor TDR (the portion 64A is formed of the same layer as that of the power feeding line 50), and the portion 64B is formed the same layer as those of the interconnection layers 126 of the driving transistor TDR. The portion 64A is disposed in the area on the opposite side of the driving transistor TDR with the power feeding line 50 interposed therebetween so as to extend in the X direction (a direction parallel to the power feeding line 50). The portion 64C is a portion which is continuous to the semiconductor layer of the transistor TR4. Accordingly, the portion 64C is formed of the same layer as that of the semiconductor layer 122 of the driving transistor TDR. As shown in FIGS. 13 and 14, the portion 64B is electrically connected to the portion 64A via a connection hole H6 which penetrates the insulating layer L1. Also, the portion 64B is electrically connected to the portion 64C via a connection hole H7 which penetrates the insulating layer L1 and the gate insulating layer L0.

The portion 643 branches in the Y direction from the portion 64A extending in the X direction so as to be continuous to the transistor TR4 (source). Accordingly, as shown in FIGS. 13 and 14, the portion 643 overlaps with the power feeding line 50 with the insulating layer L1 interposed therebetween. In addition, the portion 64C overlaps with the power feeding line 50 with the gate insulating layer L0 interposed therebetween. That is, the power feeding line 50 is interposed between the portions 64B and 64C of the initialization line 60. Accordingly, as shown in FIG. 14, the insulating layer L1 as the dielectric substance is disposed between the power feeding line 50 and the portion 643 of the initialization line 60 so as to form the capacitor CP1. The gate insulating layer L0 as the dielectric substance is disposed between the power feeding line 50 and the portion 64C of the initialization line 60 so as to form the capacitor CP2. The capacitors CP1 and CP2 are arranged in parallel between the initialization line 60 and the power feeding line 50.

Since the capacitors CP1 and CP2 are provided between the initialization line 60 and the power feeding line 50 as described above, in the same manner as the second or third embodiment, it is possible to effectively suppress a variation in the potential VEL of the power feeding line 50 or a variation in the initialization potential VRS of the initialization line 60. In addition, in the same manner as the second or third embodiment, it is possible to obtain the advantage of ensuring a capacitance value sufficient for the capacitor CP2 by using the gate insulating layer L0 thinner than the insulating layer L1 as the dielectric substance of the capacitor CP2.

### E: Modified Examples

The respective embodiments described above are modified into various forms. Hereinafter, the detailed modified examples of the respective embodiments will be described. In addition, in the examples described later, two types or more may be arbitrarily selected to be used in combination.

### (1) Modified Example 1

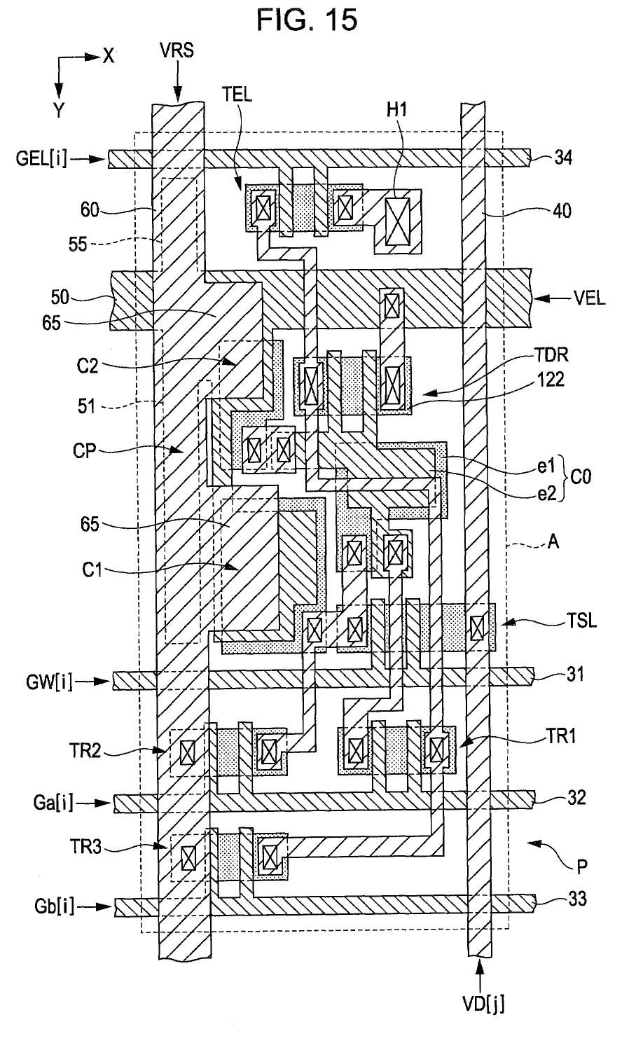

The shape of the initialization line 60 or the power feeding line 50 may be appropriately modified in view of the sufficient capacitances for the capacitors respectively provided therein. For example, as shown in FIG. 15, the initialization 60 may include the portion 65 overlapping with the power feeding line 50 (the storage capacitors C1 and C2) or the power feeding line 50 may include a portion 55 which branches to the opposite side of the branch portion 51 so as to extend in the Y direction. That is, in the invention, it is desirable to have a configuration in which the initialization line 60 overlaps with the power feeding line 50 with the insulating layer interposed therebetween in the pixel circuit P (the unit area A). The detailed shapes of the initialization line 60 and the power feeding line 50 or the extension directions thereof may be arbitrarily set.

Additionally, in the first embodiment (FIG. 4), the power feeding line 50 is provided with the branch portion 51 which branches from the intersection position between the power feeding line 50 and the initialization line 60. However, even in the configuration in which the initialization line 60 is provided with the portion extending in the X direction from the intersection position of the power feeding line 50, it is possible to increase a capacitance between the initialization line 60 and the power feeding line 50. In the same manner, in the fourth embodiment (FIG. 13), the power feeding line 50 overlaps with the portion 64B which branches from the portion 64A of the initialization line 60. However, even in the configuration in which the power feeding line 50 is provided with the portion branching in the Y direction and overlapping with the initialization line 60, it is possible to increase a capacitance between the initialization line 60 and the power feeding line 50.

### (2) Modified Example 2

In the fourth embodiment, a configuration in which the portions 64B and 64C of the initialization line 60 overlap with the power feeding line 50 is exemplified. However, a configuration in which the initialization line 60 includes one of the portions 64B and 64C (that is, a configuration in which the initialization line 60 faces only one surface of the power feeding line 50 in the same manner as the first embodiment) may be adopted.

### (3) Modified Example 3

The configuration of the pixel circuit P is not limited to the above-described examples. In the invention, it is desirable to adopt the pixel circuit P including the driving transistor TDR which controls the gray scale of the electro-optical element E in accordance with a voltage of the storage capacitor (the storage capacitors C0 to C2 shown in FIG. 2 or the storage capacitor C2 shown in FIG. 11) and the initializer (for example, the transistors TR1 to TR4) which initializes a voltage across opposite ends of the storage capacitor by electrically connecting the initialization line 60 to the storage capacitor. The detailed configurations of the other parts may be arbitrarily set.

### (4) Modified Example 4

In the above-described embodiments, the initialization line 60 or the power feeding line 50 are formed of the same layer as that of the part of the transistor (for example, the driving transistor TDR) in the pixel circuit P. However, the initialization line 60 or the power feeding line 50 may be formed by a process separate from a process of forming the transistor. Here, according to the configuration in which the initialization line 60 or the power feeding line 50 is formed of the same layer as that of the part of the transistor in the pixel circuit P, it is advantageous in that a process of forming the pixel circuit P is simplified.

### (5) Modified Example 5

The potential supplied to the power feeding line 50 overlapping with the initialization line 60 is not limited to the high level potential VEL. For example, the initialization line 60 may overlap with the power feeding line 50 to which the low level potential GND is supplied. That is, the power feeding line 50 according to the invention is specified as a wiring which supplies a predetermined potential (which may have a fixed value or a variable value) to the pixel circuit P. In addition, in the invention, the configuration in which the initialization potential VRS is a fixed potential is not essential. That is, the initialization line 60 is specified as a wiring to which the initialization potential VRS is supplied, the initialization potential VRS being used to initialize a voltage (electric charge) of the storage capacitor in the pixel circuit P.

### (6) Modified Example 6

The organic EL element is just an example of the electro-optical element E. For example, in the same manner as the above-described embodiments, the invention may be applied to the electro-optical device having an electro-optical element such as an inorganic EL element or an LED (light emitting diode) element disposed thereon. The electro-optical element according to the invention is an element of which a gray scale (brightness) changes in accordance with a current amount of the driving current IDR.

### F: Application Example

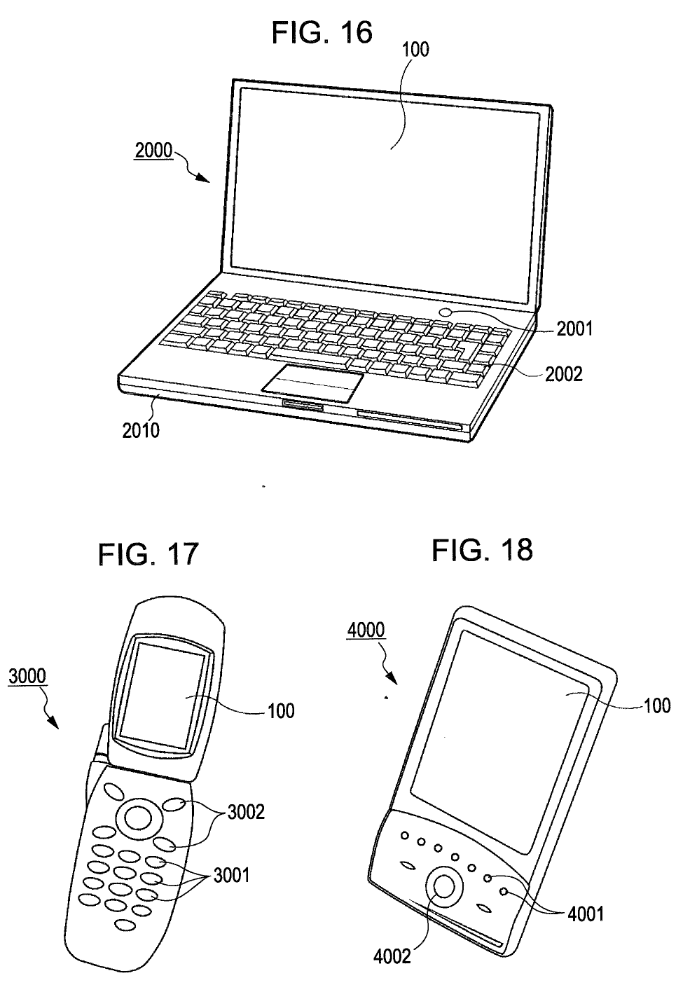

Next, an electronic apparatus adopting the electro-optical device 100 according to the above-described embodiments will be described. In FIGS. 16 to 18, the types of the electronic apparatuses adopting the electro-optical device 100 as the display device are shown.

FIG. 16 is a perspective view showing a configuration of a mobile personal computer adopting the electro-optical device 100. A personal computer 2000 includes the electro-optical device 100 which displays various images thereon and a body part 2010 which is provided with a power switch 2001 or a keyboard 2002. Since the electro-optical device 100 adopts the organic EL element as the electro-optical element E, it is possible to display an easily viewed screen having a wide FOV.

FIG. 17 is a perspective view showing a configuration of a cellular phone adopting the electro-optical device 100. A cellular phone 3000 includes a plurality of manipulation buttons 3001, a plurality of scroll buttons 3002, and the electro-optical device 100 which displays various images thereon. By means of the manipulation of the scroll buttons 3002, a screen displayed on the electro-optical device 100 is scrolled.

FIG. 18 is a perspective view showing a configuration of an information portable terminal (PDA: personal digital assistant) adopting the electro-optical device 100. An information portable terminal 4000 includes a plurality of manipulation buttons 4001, a power switch 4002, and the electro-optical device 100 which displays various images thereon. When the power switch 4002 is manipulated, information such as an address book or a schedule book is displayed on the electro-optical device 100.

An example of the electronic apparatus adopting the electro-optical device according to the invention includes a digital camera, a television, a video camera, a car navigation device, a pager, an electronic scheduler, an electronic paper, a calculator, a word processor, a workstation, a videophone, a POS terminal, a printer, a scanner, a copy machine, a video player, or an apparatus provided with a touch panel in addition to the exemplary apparatuses shown in FIGS. 16 to 18. In addition, the application of the electro-optical device according to the invention is not limited to the display of the image. For example, the electro-optical device may be used as an exposure device of an electrophotographic image forming apparatus, the exposure device being used to form a latent image on a photosensitive drum by means of exposure.

The entire disclosure of Japanese Patent Application No. 2008-178121, filed Jul. 9, 2008 is expressly incorporated by reference herein.

What is claimed is:

1. An electro-optical device comprising:
a plurality of pixel circuits, each of which is disposed at a position corresponding to each intersection position between a plurality of scanning lines and signal lines;
a power feeding line which supplies a predetermined potential to the plurality of pixel circuits; and
an initialization line which supplies an initialization potential to the plurality of pixel circuits,
wherein each of the plurality of pixel circuits includes:
an electro-optical element which has a gray scale in accordance with a current amount of a driving current supplied from the power feeding line;
a storage capacitor of which a voltage across opposite ends is set in accordance with a potential of the signal line;
an initializer which initializes the voltage across opposite ends of the storage capacitor by electrically connecting the initialization line to the storage capacitor; and
a driving transistor which controls the current amount of the driving current in accordance with the voltage of the storage capacitor, and
wherein the initialization line includes a portion which is disposed in each pixel circuit so as to overlap with the power feeding line with an insulating layer interposed therebetween.

2. The electro-optical device according to claim 1,
wherein the initialization line includes a first portion which is disposed in each pixel circuit so as to overlap with the power feeding line and a second portion which is disposed in each pixel circuit and is formed on the opposite side of the first portion with the power feeding line interposed therebetween so as to be electrically connected to the first portion.

3. The electro-optical device according to claim 2,
wherein the driving transistor includes a semiconductor layer, a gate electrode which faces the semiconductor layer with a gate insulating layer interposed therebetween, and an interconnection layer which is formed on a surface of an insulating layer covering the gate electrode so as to be electrically connected to the semiconductor layer,
wherein the power feeding line includes a portion which is formed of the same layer as that of the gate electrode,
wherein the first portion is formed of the same layer as that of the interconnection layer, and
wherein the second portion is formed of the same layer as that of the semiconductor layer.

4. The electro-optical device according to claim 1,
wherein the power feeding line includes a third portion which is disposed in each pixel circuit so as to overlap with the initialization line and a fourth portion which is disposed in each pixel circuit and is formed on the opposite side of the third portion with the initialization line interposed therebetween so as to be electrically connected to the third portion.

5. The electro-optical device according to claim 4,
wherein the driving transistor includes a semiconductor layer, a gate electrode which faces the semiconductor layer with a gate insulating layer interposed therebetween, and an interconnection layer which is formed on a surface of an insulating layer covering the gate electrode so as to be electrically connected to the semiconductor layer,
wherein the initialization line includes a portion which is formed of the same layer as that of the gate electrode,
wherein the third portion is formed of the same layer as that of the interconnection layer, and
wherein the fourth portion is formed of the same layer as that of the semiconductor layer.

6. The electro-optical device according to claim 1,
wherein the power feeding line and the initialization line extend in a direction intersecting each other, and
wherein one of the power feeding line and the initialization line includes a portion which is disposed in each pixel circuit and branches from an intersection position between the power feeding line and the initialization line so as to overlap with the other of the power feeding line and the initialization line.

7. The electro-optical device according to claim 1,
wherein the power feeding line and the initialization line extend in a direction parallel to each other, and
wherein one of the power feeding line and the initialization line includes a portion which is disposed in each pixel circuit and branches so as to overlap with the other of the power feeding line and the initialization line.

8. An electronic apparatus comprising:
the electro-optical device according to claim 1.
